(19) United States
(12) Patent Application Publication
(10) Pub. No.: US 2020/0290587 A1
(43) Pub. Date: Sep. 17, 2020

(54) WIRELESS WHEEL CHOCK

(71) Applicant: DL Manufacturing, Inc., North Syracuse, NY (US)

(72) Inventors: Gregory J. Duffy, Baldwinsville, NY (US); Kyle J. Berean, Chittenango, NY (US); Donald L. Metz, Kirkville, NY (US)

(73) Assignee: DL Manufacturing, Inc., North Syracuse, NY (US)

(21) Appl. No.: 16/889,793

(22) Filed: Jun. 1, 2020

Related U.S. Application Data
(63) Continuation-in-part of application No. 15/402,232, filed on Jan. 9, 2017, now Pat. No. 10,668,913.
Application No. 15/402,232 is a continuation of application No. 14/869,976, filed on Sep. 29, 2015, now Pat. No. 9,539,995.
(60) Provisional application No. 62/056,849, filed on Sep. 29, 2014.

(51) Int. Cl. B60T 17/22; B60T 3/00; H04N 7/18

(52) U.S. Cl. CPC B60T 17/22; H04W 84/12; H04N 7/183; B60T 3/00

(57) ABSTRACT

A wheel chock system includes a wheel chock comprising a tire contact surface, one or more support elements, and a base portion, and a sensor located proximate the wheel chock for use in detecting a chocked vehicle tire. The sensor includes an axis, a lever arm pivoting about the axis, the lever arm comprising a forward portion and a rearward portion, the forward leg portion protruding through an aperture in the tire contact surface of the chock, the lever arm having a range of motion defined by a first position wherein the forward leg protrudes through the aperture a first distance, an intermediate position wherein the forward leg protrudes through the aperture a second distance greater than zero and less than the first distance, and a third position wherein the forward leg is flush with or below the tire contact surface. A wireless module coupled to the trigger arm, the wireless module comprising a transmitter and an electrodynamic energy generator for inducing a voltage to power the transmitter.

### CROSS REFERENCE TO RELATED APPLICATIONS

This application is a continuation-in-part of, and claims the benefit and priority of, U.S. patent application Ser. No. 15/402,232, filed on Jan. 9, 2017, which is continuation of, and claims the benefit and priority of, U.S. patent application Ser. No. 14/869,976, filed on Sep. 29, 2015, now U.S. Pat. No. 9,539,995, which is a non-provisional of, and claims the benefit and priority of, U.S. Provisional Application Ser. No. 62/056,849, filed Sep. 29, 2014. The entire contents of such applications are hereby incorporated by reference.

### BACKGROUND OF THE INVENTION

The application relates to loading docks and particularly to a system and method for improving performance of loading dock wheel chock safety procedures.

Loading docks are among the most dangerous locations in a commercial space. Tractor trailer trucks need to maneuver outside the loading dock with limited space and limited visibility. Inside, fork lift trucks are moving about to and from the loading dock, also with limited space and limited visibility. Pedestrians can also be moving about both outside and inside the loading dock door.

One of the worst case accident scenarios at a loading dock can occur when a trailer unexpectedly moves away from the dock. If a forklift is between a surface of the dock and the entry to the trailer when the trailer unexpectedly moves, in almost all cases the forklift falls about four feet to the surface below the door. The forklift operator can be seriously injured, or worse, a portion of the forklift can fall on the driver causing in a fatal crush injury.

In response to such accidents, there are chock related OSHA regulations, as well as local regulations, and commercial rules regarding chock use at loading docks.

### BRIEF SUMMARY OF THE INVENTION

In accordance with one aspect of the disclosure, a wheel chock system includes a chock assembly comprising a wheel chock, a shaft, and a handle coupled to the wheel chock to place the chock against a tire of a truck or trailer wheel. A sensor disposed within the chock senses when the chock is in close proximity to the tire. The wheel chock system further includes an outside light box electrically coupled to the chock assembly. One or more lamps of the outside light box provide a visual indication of the proximity to the wheel based on the sensor, and to give one or more visual indications of a loading dock safety status. The wheel chock system further includes an inside control panel operatively coupled to the outside light box. One or more lights on the inside control panel provide a second visual indication of the loading dock safety status. The wheel chock system further includes a controller electrically coupled to the inside control panel. The controller includes a processor programmed to change visual indications of both the outside light box and the inside control panel, based at least on the sensor and a loading dock door sensor. The wheel chock system further includes a wireless module communicatively coupled to the controller to convey the loading dock safety status wirelessly over a network to provide an additional layer of wheel chock system safety oversight.

In accordance with one another aspect of the disclosure, a wheel chock system includes a chock assembly comprising a wheel chock, a shaft, and a handle coupled to the wheel chock to place the chock against a tire of a truck or trailer wheel. The wheel chock system further includes a sensor disposed within the chock to sense when the chock is in close proximity to the tire. The wheel chock system further includes an outside light box electrically coupled to the chock assembly. One or more lamps on the outside light box provide a visual indication of the proximity to the wheel based on the sensor and to give one or more visual indications of a loading dock safety status. The wheel chock system further includes an inside control panel operatively coupled to the outside light box. One or more lights on the inside control panel provide another visual indication of the loading dock safety status. The wheel chock system further includes a controller electrically coupled to the inside control panel. The controller includes a processor programmed to change visual indications of both the outside light signal box and the inside control panel, based at least on the sensor and a loading dock door sensor. The wheel chock system further includes a camera positioned to view the tire of the truck or trailer wheel and the chock. The camera is communicatively coupled to the wheel chock system to convey an image of the tire of the truck or trailer wheel and the chock to a display disposed on or near the inside control and light box to provide an additional layer of wheel chock system safety oversight.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts an illustration of a wheel chock system as viewed from the truck side of a loading dock, according to one embodiment of the invention;

FIG. 2 depicts a schematic diagram illustrating a truck trailer backed up to a loading dock having a camera directed at the wheel chock and which shows a Wi-Fi module of an exemplary Wi-Fi wheel chock system;

FIG. 3 depicts a block diagram of a data processing system in which illustrative embodiments of the present invention may be implemented;

FIG. 4 depicts a block diagram of an exemplary wireless wheel chock system configuration where a computer with a wired or wireless connection to a local network can communicate via an access point with a wireless wheel chock system;

FIG. 5 depicts a block diagram of an exemplary wireless wheel chock system configuration where a computer with a wireless module can communicate directly with the wireless module of a wireless wheel chock system;

FIG. 6 depicts a block diagram of an exemplary wireless wheel chock system configuration where a computer with an internet connection can communicate via an access point with a wireless wheel chock system;

FIG. 7 depicts a block diagram of an exemplary wireless wheel chock system configuration where a wireless device with a wireless connection to a local network can communicate via an access point with a wireless wheel chock system;

FIG. 8 depicts a block diagram of an exemplary wireless wheel chock system configuration where a wireless device with an Internet connection to a local network can communicate via an access point with a wireless wheel chock system;

FIG. 9 depicts a simplified illustration of a properly chocked trailer tire;

FIG. 10 depicts a simplified overhead exemplary illustration of an incorrectly placed chock;

FIG. 11 depicts another simplified overhead illustration of an incorrectly placed chock;

FIG. 12 depicts a block diagram of an exemplary wireless wheel chock system configuration where a computer with a connection to a network can communicate with a wireless wheel chock system, and a wireless communication module is located in the chock;

FIG. 13 depicts a side perspective view of a wireless wheel chock assembly according to one embodiment of the present invention;

FIG. 14 depicts a left side plan view of the wireless wheel chock assembly shown in FIG. 13;

FIG. 15 depicts a left side perspective view of the wireless wheel chock assembly shown in FIG. 14 with the wheel chock housing removed for clarity;

FIG. 16 depicts a right side plan view of the wireless wheel chock assembly shown in FIG. 13;

FIG. 17 depicts a right side perspective view of the wireless wheel chock assembly shown in FIG. 16 with the wheel chock housing removed for clarity;

FIG. 18 depicts an exploded perspective view of the wireless wheel chock assembly shown in FIG. 17;

FIG. 19 depicts a side plan view of the wireless wheel chock assembly shown in FIG. 13 with the sensor in a first, pre-loaded position;

FIG. 20 depicts a magnified view of FIG. 19;

FIG. 21 depicts a side plan view of the wireless wheel chock assembly shown in FIG. 13 with the sensor in a second, intermediate position;

FIG. 22 depicts a magnified view of FIG. 21;

FIG. 23 depicts a side plan view of the wireless wheel chock assembly shown in FIG. 13 with the sensor in a third, maximum-travel position;

FIG. 24 depicts a magnified view of FIG. 23; and

FIG. 25 depicts various plunger positions for a position switch according to one embodiment of the present invention.

### DETAILED DESCRIPTION OF THE INVENTION

Definitions: Wireless module: A wireless module includes any suitable form of wireless communications such as, for example, Wi-Fi, ZigBee, XBee, communication over power lines, or any other suitable form of wireless communications, such as any suitable type of radio frequency (RF) wireless communications. While referred to hereinbelow as a wireless “module”, wireless module is understood to include wireless functionality added by one or more wires, PC posts, or cables literally connected to a wireless module, as well as the equivalent wireless functionality on any suitable circuit board, such as can be provided by one or more discrete components and/or integrated and/or hybrid circuits mounted to one or more circuit boards associated with a controller. The method of construction such as, for example, through hole components, surface mount components, and or more compact technologies such as flip chips and/or other solder bump compatible packages are all understood to fall within the definition of wireless module as used hereinbelow.

Operatively coupled: Operatively coupled as used herein includes both wired and wireless connectivity such as any suitable form of communicatively coupled. For example, in practice, the “outside light box” is typically wired by a cable through a wall to an “inside light box” as described hereinbelow. However, it is unimportant to the new system and method how the outside box is operatively coupled to the system, typically receiving information from a controller which can be mounted inside the inside light box for convenience of packaging or in another enclosure, typically inside of the building, and typically mounted near the inside light box. For convenience of supplying power to the outside light box, the outside light box, again is typically hardwired to either the inside light box or another related electronics enclosure typically housing the controller electronics and ancillary contact devices, such as, for example electro-mechanical relays, or solid state switches used to control one or more series of lamps (e.g. a string of LEDs) in each of the light boxes. However, there can be embodiments, for example, where an outside light box receives power from an electrical power source independent of electrical power which powers the inside light box and/or the controller mounted inside of the loading dock. In such cases, it is contemplated that the outside light box can be wirelessly coupled to the controller (which may or may not be physically mounted in the inside light box) by any suitable wireless means, such as, for example, those used for the wireless module as described herein. A wirelessly coupled outdoor light box can be powered by any suitable means, such as, for example by one or more batteries of any suitable type (e.g. as charged by a local dedicated or non-dedicated photovoltaic panel and battery charger) or hardwired into any suitable source of AC power or DC power available outside of the loading dock near where the outside light box is mounted to the outside loading dock wall.

As described hereinabove, loading docks are among the most dangerous locations in a commercial space. Tractor trailer trucks need to maneuver outside the loading dock with limited space and limited visibility. Inside, fork lift trucks are moving about to and from the loading dock, also with limited space and limited visibility. Pedestrians can also be moving about both outside and inside the loading dock door.

One of the worst case accident scenarios at a loading dock can occur when a trailer unexpectedly moves away from the dock. If a forklift is between a surface of the dock and the entry to the trailer when the trailer unexpectedly moves, in almost all cases the forklift falls about four feet to the surface below the door. The forklift operator can be seriously injured, or worse, a portion of the forklift can fall on the driver causing in a fatal crush injury.

While, there are chock related OSHA regulations, as well as local regulations, and commercial rules regarding chock use at loading docks, such accidents still happen.

Much progress has been made towards improving loading dock safety. For example, through a combination of signal lights, audio alarms, and interlocks, the Smart Chock™ brand sensor system (available from DL Manufacturing of North Syracuse, N.Y.) has been widely used to enforce safe chock practice. However, even with the extensive use of the local signaling and alarming offered by the Smart Chock™ sensor system, a system and method which offers still more oversight and/or better enforcement of proper chock use and chock procedure at the loading dock is needed.

Furthermore, in facilities having a large number a loading docks, a logistics problem arose when engineers attempted to integrate wired wheel chock sensor input from numerous wheel chocks. Specifically, the system had to be “daisy-chained,” meaning each unit was tied to another in series, and the wheel chock sensor signals passed from one device to the next before finally arriving at an end interface. This scheme became prohibitive in terms of installation complexity and hardware costs when incorporating large numbers of units. The cost of running wires was unmanageable due to each facility's particular layout and floorplan—may had crowded and difficult-to-install areas that prevented running the large numbers of wires required to operate the system.

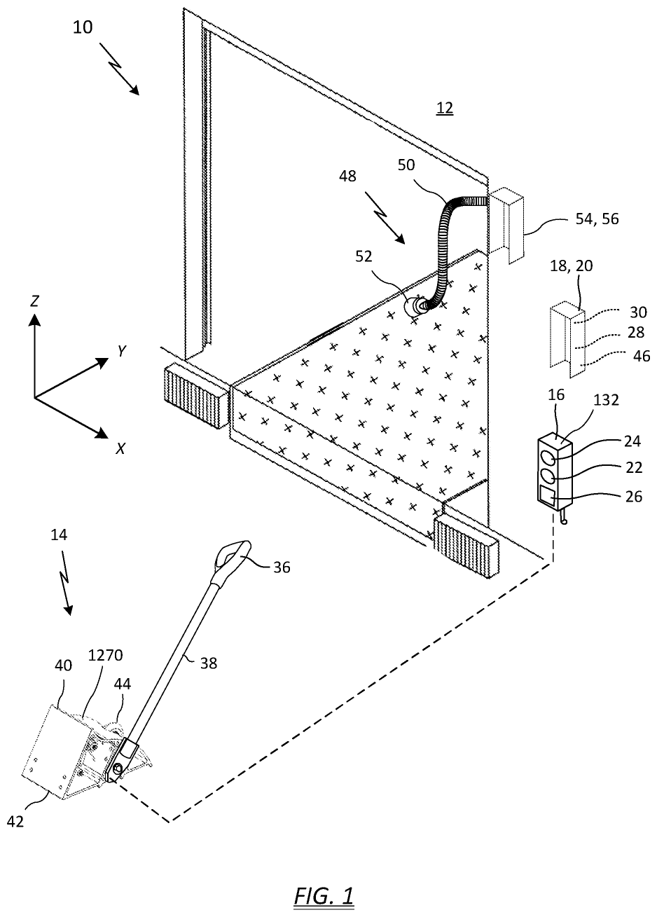

FIG. 1 shows an illustration of one exemplary embodiment of a wheel chock system 10 as viewed from the truck side of a loading dock 12. For purposes of illustration and to further explain orientation of certain features of the invention, a lateral axis is defined as substantially parallel to the loading dock wall and is denoted as the x-axis; a longitudinal axis is defined as substantially in the direction of vehicle motion when backing into the loading dock and is denoted as the y-axis; and the vertical axis is denoted as the z-axis. The wheel chock system 10 includes a wheel chock assembly 14, an exterior-mounted outside light box 16, an interior-mounted inside control panel 18 (shown in dashed lines because it is located on the other side of the loading dock wall), and a controller 20. In the illustrated embodiment, the controller 20 is disposed inside the inside control panel 18. The outside light box 16 includes a green lamp 22, a red lamp 24, and a red chock icon 26. The inside control panel 18 includes a green chocked lamp 28 and a red unchocked lamp 30.

In operation, as a driver backs up to a closed overhead door, the green lamp 22 flashes on the outside light box 16, indicating it is safe to proceed. A light baffle around the red and green lamps (typically high-brightness LEDs) cause the lights to be visible only to the driver in the cab of a truck in the lane corresponding to a particular loading dock. Concurrently, the inside control panel 18 illuminates the red unchocked lamp 30, indicating the trailer is not chocked and it may be unsafe to open the overhead door.

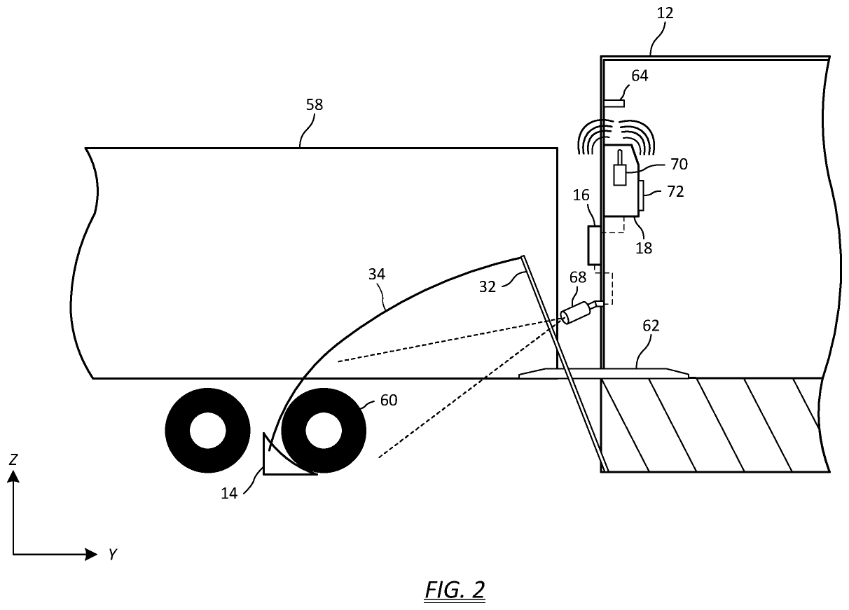

After backing into the loading dock 12, the driver locates the wheel chock assembly 14, which can only be moved within a distance of that loading dock as set by the cable length. A cable pole 32, such as a fiberglass pole, helps to keep the cable 34 off the ground and out of the way when the wheel chock assembly 14 is not in use (FIG. 2). The driver can take hold of the wheel chock assembly 14 by a handle 36 at the end of a shaft 38, such as a fiberglass shaft. The driver then follows safe wheel chock procedures and places the wheel chock 40 under the truck tire (not shown). In some embodiments, a non-skid saw-tooth back plate 42 helps to positively secure the back foot of the chock to the ground surface.

A sensor 44 may be operatively associated with the wheel chock system 10 to detect the presence of the chocked tire. In one possible implementation, the contact surface of the wheel chock 40 defines an aperture, and the sensor 44 is adapted to measure the presence of the truck tire through the aperture. The sensor 44 may be any type of data-gathering, data-transmitting device that is suitable for the conditions. In one example, the sensor 44 may be an ultrasonic device that includes an ultrasonic transducer or transceiver adapted to generate high frequency sound waves and evaluate the echo which is received back by the sensor. By measuring the time interval between sending the signal and receiving the echo, the sensor can determine if a truck tire is present over the aperture. In another example, the sensor 44 may be a proximity-sensing photoelectric sensor in which an emitter is adapted to transmit a beam of light (such as pulsed infrared, visible red, or laser) that diffuses through the aperture. As the wheel covers the aperture, part of the light beam deflects back to a receiver, detection occurs, and an output may be transmitted to a controller or microprocessor.

When the trailer is parked and chocked, the sensor 44 in the wheel chock 40 relays the condition to the controller 20, which sends a command to illuminate the chock icon 26 and turn off the green lamp 22 on the outside light box 16. With the outside red chock icon 26 illuminated, a driver checking the rear view mirror can positively see that the trailer wheel is still chocked. Concurrently, the red unchocked lamp 30 turns off and the green chocked lamp 28 illuminates on the inside control panel 18, indicating the trailer is chocked and it is safe to open the overhead door. The inside control panel 18 is typically mounted to an inside wall in the immediate vicinity of a loading dock door (e.g., a sectional door) of the same loading dock, such as for example, by fasteners. The inside control panel 18 also may include an audio alarm 46 for alerting personnel to unsafe conditions as described in more detail hereinbelow.

FIG. 1 also depicts an exemplary trailer illumination lamp 48 having a flexible, adjustable shaft 50 to provide lighting inside the trailer for loading and unloading operations. After the loading dock door is opened, the adjustable shaft 50 may be positioned to point the lamp bulb (encased by bulb shield 52) into the trailer. In some embodiments, the adjustable shaft 50 may be formed of flexible stainless steel tube, and a cooling fan 54 located in a base housing 56 may push air through the flexible stainless steel tube to reduce the lamp bulb temperature, thereby extending the bulb service life. The base housing 56 may be mounted to an inside wall so as to prevent blocking the doorway. The illumination lamp 48 can also be used to supplement alarm signals, such as by blinking on and off.

FIG. 2 depicts a schematic block diagram showing a truck trailer 58 backed up to the loading dock 12. The trailer 58 has been properly chocked by wheel chock assembly 14 placed against wheel 60. Typically, a loading dock sectional door is opened, followed by operation of a loading dock leveler 62 to make a relatively flat bridge for personnel and forklifts to proceed to and from the loading dock and trailer. Once the leveler is correctly positioned, a personal safety restraint, such as a chain across the loading dock door, can be opened and loading or unloading operations can then safely proceed. Once the loading dock door has opened, the red lamp 24 on outside light box 16 illuminates to alert those outside in the same loading dock lane that the loading dock door is open.

Because loading dock operations can involve potentially dangerous activities, many embodiments of the exemplary wheel chock system 10 include various responses to the wheel chock sensor 44, a door sensor 64, and a safety chain sensor 66 (not shown) to automatically sense safety conditions and to alarm on detection of a unsafe loading dock condition. In one example, the outside light box 16 may include an audio alarm 46 for sounding during unsafe conditions as described in more detail hereinbelow. In another example, if wheel chock 40 is removed prematurely with the loading dock door open, the green chocked lamp 28 on the inside control panel 18 turns off, the red unchocked lamp 30 turns on, and an outside audio alarm 46 turns on. In yet another example, if the loading dock door opens without a truck wheel chocked, the illumination lamp 48 flashes and the inside audible alarm 46 sounds. Additionally, the outside red chock icon 26 turns off, the outside red lamp 24 illuminates, and an outside audio alarm 46 activates. In one exemplary system failure mode, if communication between the wheel chock assembly 14 and the inside control panel 18 is severed, lost, or disconnected, such as by severing chock cable 34, the inside green chocked lamp 28 and red unchocked lamp 30 alternately flash from green to red, an on-board yellow system LED (not shown) illuminates, and the outside red lamp 24 illuminates. If the wheel was chocked, chock icon 26 turns off and outside audio alarm 46 sounds.

As can now be seen, the various lights and alarms of the exemplary wheel chock system are intended to guide the truck driver and personnel at the loading dock through a safe loading dock chock operation, including adherence to safe wheel chock procedures. When the wheel chock system detects a breach of the loading dock safety procedures or other safety hazard, the wheel chock system attempts to draw the attention of any personnel in the immediate location of the loading dock to an unsafe condition.

However, it has been realized that despite the numerous safety features described hereinabove, it may still be possible for personnel at the loading dock to defeat one or more interlocks or to defeat proper chocking such as, for example, by intentionally or accidentally causing wheel chock assembly 14 to indicate that it is correctly installed under a truck tire when it is not. While almost no commercial system can guarantee a perfectly failsafe operation, loading dock operations can be so hazardous and fast paced, it was realized that further levels of system safety monitoring are needed.

Accordingly, FIG. 2 further depicts a truck trailer 58 backed up to the loading dock 12 and having a camera 68 pointed at the wheel chock 40, and which shows a wireless module 70 of an exemplary Wi-Fi wheel chock system. The wireless module 70, which may be a Wi-Fi module, is operatively coupled to inside control panel 18 by any suitable means, such as for example, via a serial connection such as by a RS/EIA/TIA-232 or RS/EIA/TIA-485 serial connection interface. An optional LCD display 72, here provided as part of the inside control panel 18, allows an operator to see the image from camera 68 and/or to read wheel chock system information directly at the loading dock.

The Wi-Fi portion of a wheel chock system allows for safety personnel to be able to actively monitor events on the loading dock, while not having to be physically present at the loading dock. Now, persons beyond the loading dock are able to access the loading dock information available from the wheel chock system of every loading dock door from any remote location with access to the Wi-Fi network in, such as, for example, via the Internet.

In one example, a worker opens a loading dock door to load a truck without the truck being properly chocked. The result is an alarm sounding as well as the safety personnel being wireless notified by any suitable means, such as, for example via their computer and/or smartphone and/or other suitable mobile device.

Along with enhanced safety, there can also be energy savings and environmental awareness by the addition of the wireless wheel chock system reporting features. For example, there can be energy conservation and monitoring by only allowing the loading dock Fan and Light to be on when the loading dock door is open through wired or wireless control means (e.g., wireless power control modules).

In another example, large facilities with a high number loading dock doors may desire to conserve as much energy as possible. With the wheel chock system monitoring system, users are able to monitor the time duration of light and/or fan operation and thus determine an approximate amount of power usage. Remote users can determine if the loading docks are consuming more power than intended by remote monitoring and take action to change the loading dock operation to better meet desired energy usage goals.

The monitoring system may also record occurrence times and calculate the time between events to obtain efficiency metrics. In one example, a large facility desires to increase the efficiency of loading dock times as much as possible. A user of the Wi-Fi wheel chock system and method as described herein is able to monitor, record, and study loading dock operation information as can be transmitted from the loading dock.

Because the loading dock is an entry portal into a commercial facility, loading dock information sent by the Wi-Fi wheel chock system and method as described herein (e.g., a door open event) can be used to enhance facility security monitoring. In one example, a particular company normally operates its loading dock only during regular business hours. A wireless communication from the wheel chock system indicates that a door has been opened during a time outside of normal operating hours. The monitoring system can also be set to specifically alert security personnel of loading dock events during a particular time period (e.g., outside of normal working hours) via text message/email/other to provide enhanced loading dock security.

The controller 20 can be communicatively coupled to the wireless module 70 by any suitable means. In some embodiments, wheel chocks can be coupled to the wireless module by a RS/EIA/TIA-232 or a RS/EIA/TIA-485 serial connection interface.

In one implementation, each wheel chock system 10 can be assigned a unique IP address. The IP address can be coded for a corresponding loading dock location. For example, a “loading dock 47” might be assigned the IP address 10.24.70.047 and a “loading dock 48” assigned an IP address of 10.24.70.048. The IP address can be entered into the Wi-Fi module 70 of a wheel chock system by any suitable IP address entry technique. For example, in embodiments with a touch sensitive LCD display 72, or where there is a local keypad or keyboard, the IP address can be entered via the LCD display. The IP address can be set by a portable computer temporarily connected to the wireless module, such as through the RS-232 port on the conversion module. Or, in some embodiments, the IP address can be set or set wirelessly by accessing the RS-232 to Wi-Fi converter via a network access point (similar to configuring a router).

In some embodiments, the wheel chock system 10 can send wireless messages, such as wireless messages sent by a Wi-Fi module. Exemplary Wi-Fi wheel chock system messages—wireless (e.g., Wi-Fi) wheel chock system messages can be sent using any suitable characters or encoding. Exemplary messages include “CHOCKED”, “DOOR MOVING”, “DOOR OPEN”, “DOOR CLOSED”, “UNCHOCKED”, etc. Typically, unique names or codes are assigned to each message. For example, the message “CHOCKED” can be “:CHKD!”. The same message can be sent, for example, as an ASCII code, a HEX code, a binary code, or by any other suitable encoding method. There can be a character which announces a message, such as, for example “:”. There can also be a character to indicate the end of a message, such as, for example, “!”. The exact coding or format of a wireless wheel chock system message is unimportant to the system and method described herein. It is also unimportant if the actual coded message literally include letters representing a physical item. For example, the system can be configured to recognize the message “:2;T!” as meaning door moving.

Typically, an application program, such as, for example, any suitable executable code may be running on a computer or device intended to receive such wireless wheel chock system messages. In some embodiments, there can be two-way messaging, where, for example, a supervisor realizing an unsafe loading dock condition from received messages or other indication received at the remote location (e.g., an image as described hereinbelow), can stop or inhibit some or all loading dock functions by use of a remote computer or a remote mobile device.

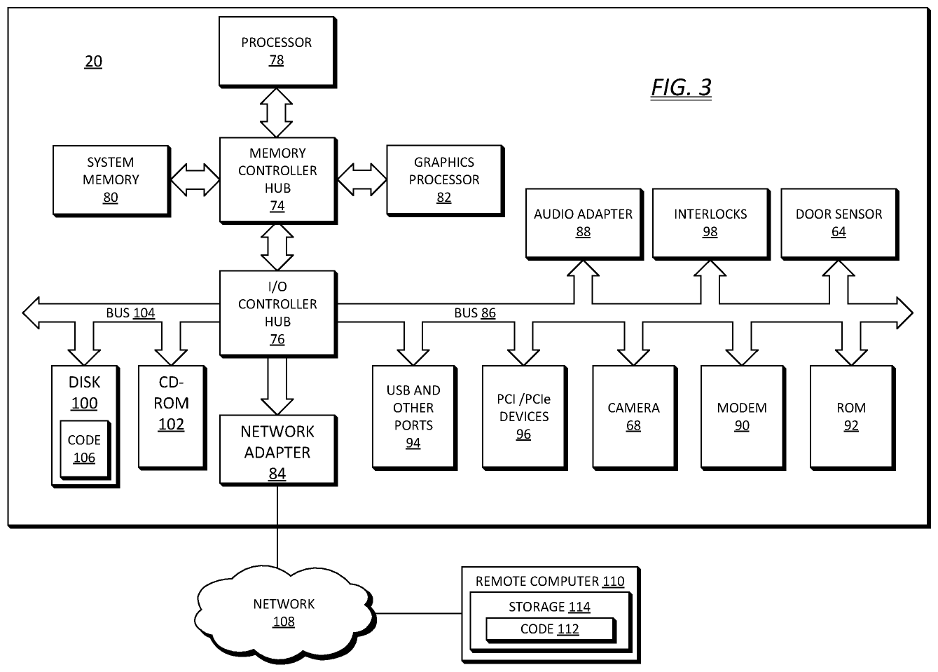

FIG. 3 schematically depicts a block diagram of an exemplary data processing system 20 that may be utilized by and/or in the implementation of the present invention. The processing system 20 may be realized as a computer, controller, mobile device, or another type of device in which computer usable program code or instructions can implement the processes disclosed herein. Some of the exemplary architecture shown for and within data processing system 20, including both depicted hardware and software, may be eliminated without departing from the general description of the operations and functions of data processing system described herein. Non-limiting examples of computers include servers, clients, laptop computers, or tablet computers. A non-limiting example of a controllers includes a microcontroller with somewhat limited functions and capabilities. Non-limiting examples of mobile devices include smart phones and personal digital assistants.

In the depicted example, data processing system 20 employs a hub architecture, such as North Bridge and memory controller hub 74, and South Bridge and input/output (I/O) controller hub 76. Processor 78, main system memory 80, and graphics processor 82 are coupled to the memory controller hub 74. Processor 78 may contain one or more processors, may be a multi-core processor, and may be implemented using one or more heterogeneous processor systems. Graphics processor 82, which drives/supports display 72 or other displays, may be coupled to memory controller hub 74 through an accelerated graphics port (AGP) in certain implementations.

In the depicted example, local area network (LAN) network adapter 84 is coupled to I/O controller hub 76, and may include an RJ-45 jack and/or a wireless chip. I/O controller hub 76 affords communication with various I/O devices through I/O bus 86. I/O devices can include for example audio adapter 88, camera 68, door sensor 64, modem 90, read only memory (ROM) 92, universal serial bus (USB) and other ports 94 (which may include a USB keyboard and mouse adapter), Peripheral Component Interconnect (PCI)/PCI Express (PCIe) devices 96, and various interlocks 98 that may be activated when pre-set conditions are satisfied. Exemplary interlocks 98 include commands to illuminate the lamps or indicators in the outside light box 16 and the inside control panel 18. PCI/PCIe devices 96 may include, for example, flash memory devices, Ethernet adapters, add-in cards, and PC cards for notebook computers. PCI uses a card bus controller, while PCIe does not. ROM 92 may be, for example, a flash binary input/output system (BIOS).

Hard disk drive (HDD) or solid-state drive (SSD) 100 and CD-ROM 102 are coupled to I/O controller hub 76 through second I/O bus 104. Hard disk drive 100 and CD-ROM 102 may use, for example, an integrated drive electronics (IDE), serial advanced technology attachment (SATA) interface, or variants such as external-SATA (eSATA) and micro-SATA (mSATA). Although not illustrated, a super I/O (SIO) device may be coupled to I/O controller hub 76 through I/O bus 86.

Memories, such as main system memory 80, ROM 92, or flash memory (not shown), are some examples of computer usable storage devices. Hard disk drive or solid state drive 100, CD-ROM 102, and other similarly usable devices are some examples of computer usable storage devices including a computer usable storage medium.

An operating system runs on processor 78. The operating system coordinates and provides control of various components within the data processing system 20. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 20. In one example, application programs may include programs and logic to initiate the interlock features 98 of the wheel chock system 10.

Instructions for the operating system, the object-oriented programming system, and applications or programs are located on storage devices, such as in the form of code 106 on hard disk drive 100, and may be loaded into at least one of one or more memories, such as main system memory 80, for execution by the processor 78. The processes of the illustrative embodiments may be performed by processor 78 using computer implemented instructions, which may be located in a memory, such as, for example, main system memory 80, read only memory 92, or in one or more peripheral devices.

Furthermore, in another example, code 106 may be downloaded over network 108 from remote computer 110, where similar code 112 is stored on a storage device 114. In another case, code 106 may be downloaded over network 108 to remote computer 110, where downloaded code 112 is stored on a storage device 114.

Data processing system or controller 20 is able to communicate with the remote computer 110, which may include mobile devices, using network adapter 84 to accesses network 108. Network interface 84 may be a hardware network interface, such as a network interface card (NIC), etc. Network 108 may be an external network such as the Internet, or an internal network such as an Ethernet or a virtual private network (VPN). In one embodiment, access to the network 108 is via a wireless access point 116 (FIGS. 4, 6-8), which is a wireless modem that allows devices that are compliant with a wireless protocol (e.g., IEEE 802.11x—“Wi-Fi”) to wirelessly access network 108. Note that wireless access point 116 affords mobile devices access to network 108 (e.g., the Internet), and also affords the controller 20 direct access to the mobile devices.

Other examples of the wireless network depicted by network 108 include, but are not limited to, a near field communication (NFC) network (in which devices communicate at ranges of 4 cm or less); personal area networks (PANs), such as those that use industrial, scientific, and medical (ISM) radio bands and protocols defined in the Institute of Electrical and Electronics Engineers (IEEE) 802.15.1 standard for wireless communications within a few meters; as well as a wireless local area network (WLAN), such as a Wi-Fi network, which enables wireless communication in a range of approximately 100 meters in accordance with the IEEE 802.11x standards.

Note that the hardware elements depicted in controller 20 are not intended to be exhaustive, but rather are representative of typical components which may be required by various embodiments of the present invention. For instance, controller 20 may include alternate memory storage devices such as magnetic cassettes, digital versatile disks (DVDs), Bernoulli cartridges, and the like. These and other variations are intended to be within the spirit and scope of the present invention.

Referring to FIG. 4, wherein like numerals indicate like parts from FIGS. 1-3, depicted is a block diagram of components in an exemplary wireless wheel chock system 410 configuration where a remote computer 4110, such as a laptop, personal computer, or mobile device, having a wireless connection to a local network can communicate via an access point to receive wheel chock system information. The inside control panel 18 and controller 20 (FIG. 1) may be operatively coupled to a wireless module 470, such as a Wi-Fi module, by a RS/EIA/TIA-232 or a RS/EIA/TIA-485 serial connection interface 118. The wireless module 470 can be mounted to the inside control panel 18, to the wheel chock assembly 14, or at any other suitable exterior or interior location. Typically wireless module 470 may be mounted near or within the inside control panel 18, which can also house the controller 20. In one embodiment of FIG. 4, wireless module 470 communicates data and information from the wheel chock system 10 via a local Wi-Fi network wireless point, such as, for example, Wi-Fi wireless access point 4116. Any suitable computer 4110 can communicate via Wi-Fi 4120 with the local Wi-Fi network to receive wheel chock system information 4122 from Wi-Fi module 470.

FIG. 4 also depicts an exemplary wireless wheel chock system 410 configuration where a computer cabled to a Wi-Fi access point can communicate via an access point to receive wheel chock system information. Wireless module 470, which may be a Wi-Fi module, communicates wheel chock system information via a local Wi-Fi network wireless point, such as, for example Wi-Fi wireless access point 4116. Any suitable computer 4110 directly wired 4124 to the wireless access point 4116 can communicate via the access point to receive wheel chock system information 4122 from Wi-Fi module 470.

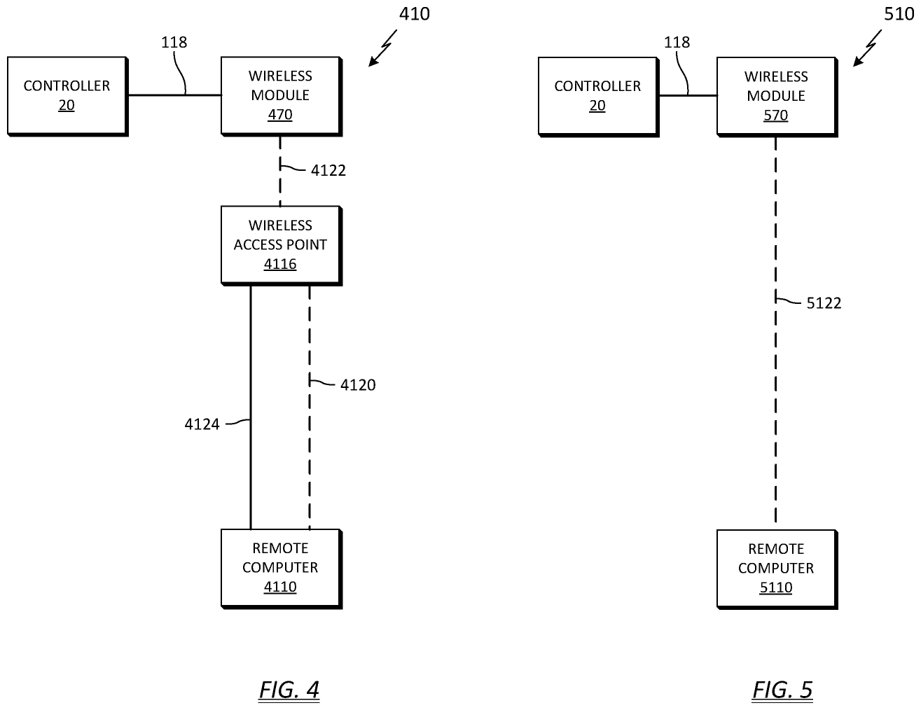

Referring to FIG. 5, wherein like numerals indicate like parts from FIGS. 1-3, depicted is an exemplary wireless wheel chock system 510 configuration where a computer with a Wi-Fi module can communicate directly with the Wi-Fi module of a wheel chock system 10 to receive wheel chock system information. Wireless module 570, which may be Wi-Fi module, communicates wheel chock system information 5122 directly with any suitable computer 5110 having a Wi-Fi module to directly receive wheel chock system information from Wi-Fi module 570.

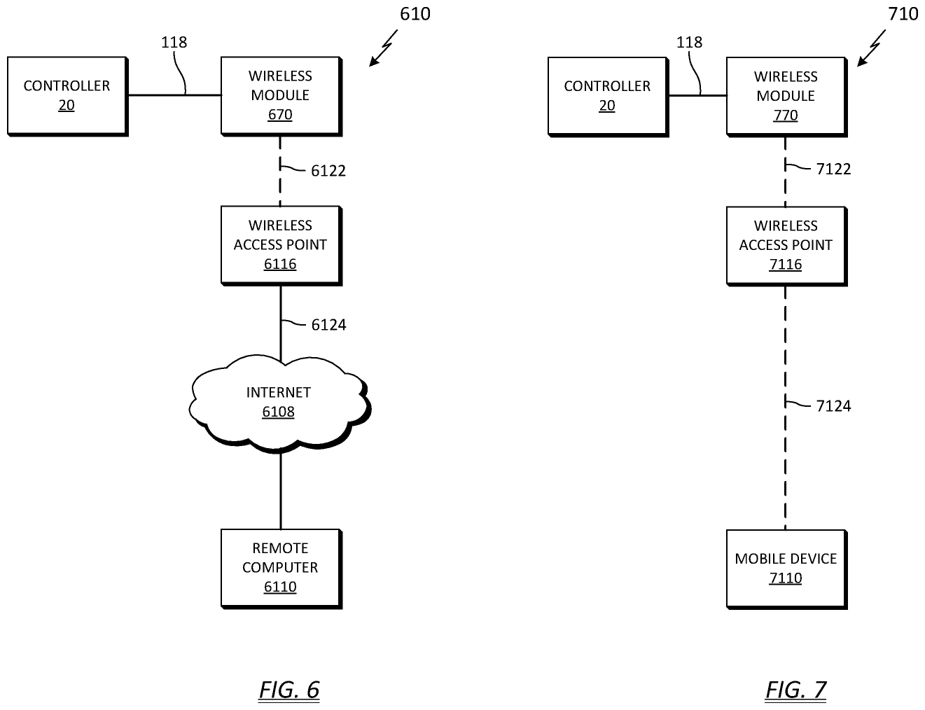

Referring to FIG. 6, wherein like numerals indicate like parts from FIGS. 1-3, depicted is an exemplary wireless wheel chock system 610 configuration where a computer with an Internet connection can communicate via an access point to receive wheel chock system information. Wireless module 670, which may be a Wi-Fi module, communicates wheel chock system information 6122 via a local Wi-Fi network wireless point, such as, for example Wi-Fi wireless access point 6116. Any suitable computer 6110 connected to the Internet 6108 can communicate 6124 via Wi-Fi access point 6116 via the Internet to receive wheel chock system information 6122 from Wi-Fi module 670.

Referring to FIG. 7, wherein like numerals indicate like parts from FIGS. 1-3, depicted is an exemplary wireless wheel chock system 710 configuration where a wireless device with a Wi-Fi connection to a local Wi-Fi network can communicate via an access point to receive wheel chock system information. As depicted by the dashed line, wireless module 770, which may be a Wi-Fi module, can communicate wheel chock system information 7122 via a local Wi-Fi network wireless point, such as, for example Wi-Fi wireless access point 7116. Any suitable wireless device, such as mobile device 7110, which can access the local Wi-Fi network, such as, for example by Wi-Fi access point 7116, can communicate via Wi-Fi access point to receive wheel chock system information from Wi-Fi module 770.

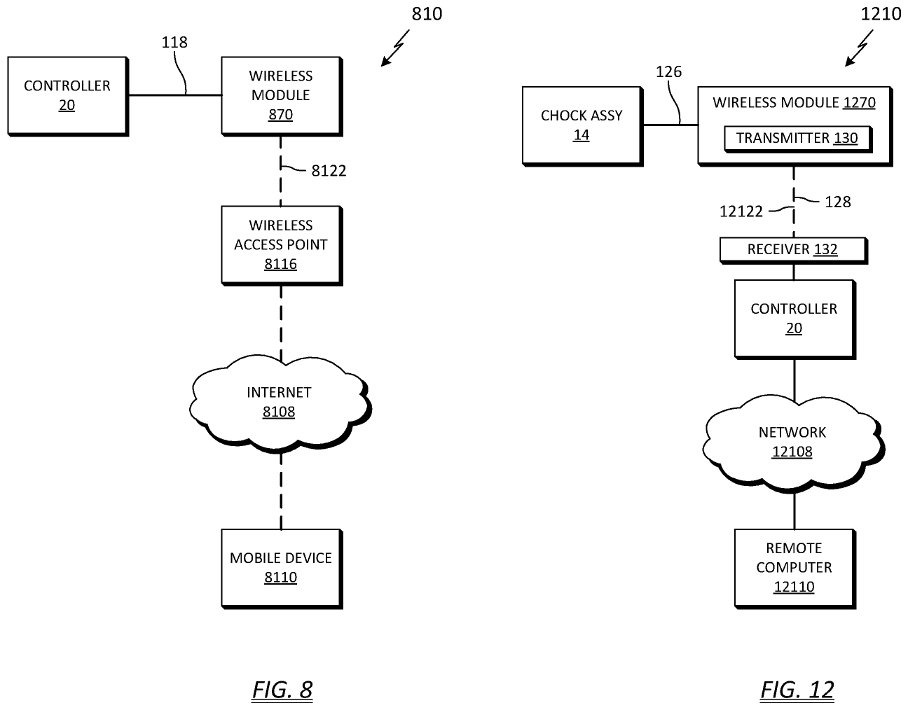

Referring to FIG. 8, wherein like numerals indicate like parts from FIGS. 1-3, depicted is an exemplary wireless wheel chock system 810 configuration where a wireless device with an Internet connection to a local Wi-Fi network can communicate via an access point to receive wheel chock system information. Wireless module 870, which may be a Wi-Fi module, can communicate wheel chock system information 8122 via a local Wi-Fi network wireless point, such as, for example Wi-Fi wireless access point 8116. Any suitable wireless device, such as mobile device 8110, which can access the Internet 8108 can communicate via Wi-Fi access point 8116 via the Internet to receive wheel chock system information from Wi-Fi module 870.

Wired Embodiments: There may be installations where it is preferable to create the equivalent of the wireless network connections described in detail herein above in part or in whole by wired cables (e.g. a network of loading dock systems wired to one or more central computers or network hubs by a plurality of RS-485 cables). It is contemplated that such hardwired systems might be advantageous in commercial or factory settings with severe radio frequency interference (RFI) or severe electromagnetic interference (EMI) at or near the loading dock controllers. For hardware cabled networks of loading dock controllers, there can be dedicated controllers with any suitable form of digital outputs, such as, for example, digital line drivers to drive hardwired cables in particularly electrically noisy environment's. There can also be embodiments with both wireless connectivity and hardwired options available on the same controller board. There can also be embodiments with optional plug-in modules for either wireless connectivity or hardwired options (e.g. a cable line driver module) available on the same controller board. The exact physical configuration of wired or wireless electronic circuitry provided on or near a controller board (e.g. provided as a separate module, separate package, or as components mounted on or near the controller) which provides either wired or wireless connectivity for a network of loading dock controllers is unimportant to the new system and method of networking one or more loading dock controllers at a facility.

In some embodiments, using any of the communication methods described hereinabove, in addition to receiving wheel chock system information, there can be two-way communication between a remotely controlled component (e.g., some component of the building HVAC system near the loading dock such as a fan or adjustable vane) or a person at a remote computer or mobile device. For example in some embodiments, a fan commanded off can automatically reply that the fan is off. Or, in some embodiments a person at a remote computer can send a message that can be displayed on a display at the loading dock.

The wheel chock system 10 may also include a LCD display 72 that can display wheel chock system information. In some embodiments, the display can show a data log of events which occurred over a particular time period to a local user at the loading dock. Typically, any data such as data regarding wheel chock operation, loading door operation and data entered into, or displayed by a local display (e.g., a local LCD display) can also be transmitted to the network via any suitable wireless means, such as by a Wi-Fi module.

In some embodiments, a user can input an identification tag, such as, for example, a PIN, a name, a signature, or a code (e.g., a barcode in a NFC, QR, or other format) that can be stored or transmitted. Once one or more IDs have been entered into a wheel chock system, there can be one or more levels of authorized use by the one or more IDs. For example, there can be one or more of the stored IDs authorized to operate the loading dock including loading dock operations that can be interlocked by a wheel chock system, such as, for example, the door leveler or door opener functions.

It was realized that in some loading dock situations, yet another or different level of safety review can be used or is needed to ensure proper chock placement against the tire of a truck or trailer wheel. A camera can be mounted in or near the outside light box (e.g., in a typical camera weather resistant housing), or inside a building or loading dock where there is a view of the outside loading dock and the tire of a truck or trailer wheel, such as through a window or camera view port. The camera can be used to confirm that the chock has been placed properly. The camera can send an image by any suitable digital or analog means to a wheel chock system at the loading dock. In some embodiments, where there is a local wheel chock system display (typically a LCD display), the wheel/chock image can display directly on the local display for the operator of the loading dock door to visually approve the wheel chock placement before operating the loading dock door and door leveler. In wireless embodiments, the image can also be sent out wirelessly (e.g., over a network) for additional review by another person such as a supervisor to review. In some embodiments, the image from the camera can be sent via a RS-232 converter to the wireless module which then sends the image data from the Wi-Fi module to the network.

It is contemplated that in some embodiments, an image recognition process running on a processor of the controller or on another computer can be used to automatically indicate if the chock is properly and safely positioned against the tire of the truck or trailer wheel based on the image of the truck or trailer wheel and the chock.

It is contemplated that an image recognition process can be adapted to automatically detect proper chock placement, such as, for example, to detect when a chock is making proper contact with a truck or trailer tire. Any suitable feature of an image of the tire and/or chock can be used. For example, it is contemplated that taking into account camera viewing angle and camera distance from the chock and tire, it can be possible to program a process that can outline the tire and chock and determine the relationships between the outline of the tire and an outline of the chock, and to calculate if the chock is in contact with the tire. For example, the process can consider dimensions such as the spacing between the edge of the chock and the edge of the tire at one or more points along the tire and/or along a surface of the wheel chock. In some embodiments, there can also be motion detection process where if the tire is detected to have any motion, the routine assumes the chock is not correctly preventing tire movement and sounds an alarm and/or activates a loading dock equipment interlock. There can be a threshold of motion detection, where for example, a strong wind might cause some limited trailer rocking motion. There can also be chock placement detection based an absence of a chock in the image, where, for example, when properly placed, the chock is mostly or entirely obscured by the tire. Any suitable image recognition parameters can be used for an image recognition process to find the tire and/or chock in an image, such as to identify a boundary line or outline of the tire and/or chock. For example, the image recognition routine can use parameters, such as, for example, colors, shapes, or any other suitable features of the truck or trailer wheel and/or the wheel chock. Objects can be intentionally color coded or marked with position or boundary marks (human eye visible or not) that can show in the image. For example, in some embodiments, the chock handle shaft is colored yellow and an unfinished chock can appear to be a metallic grey on a color image of the wheel chock assembly.

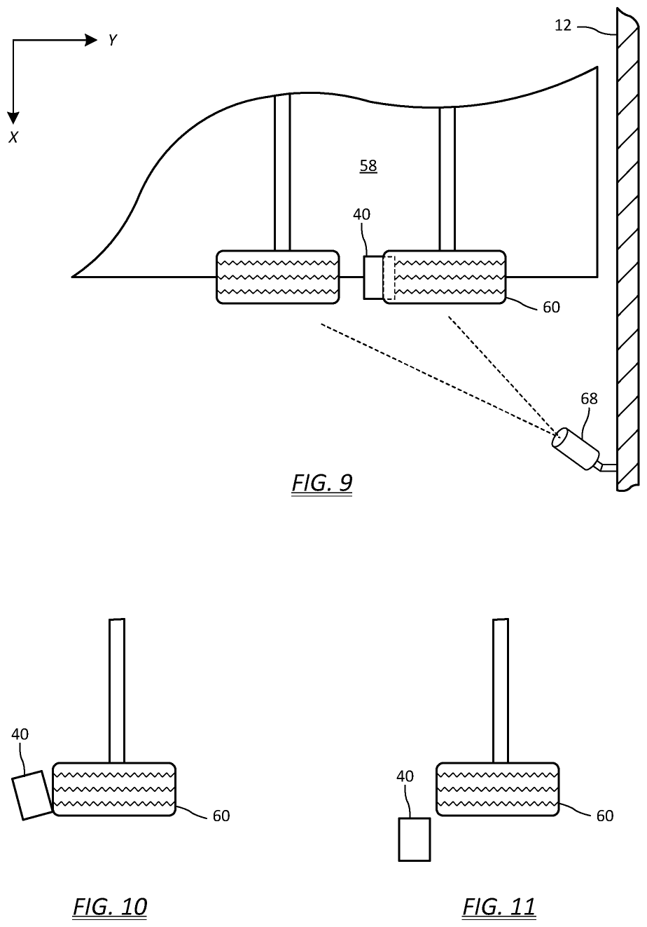

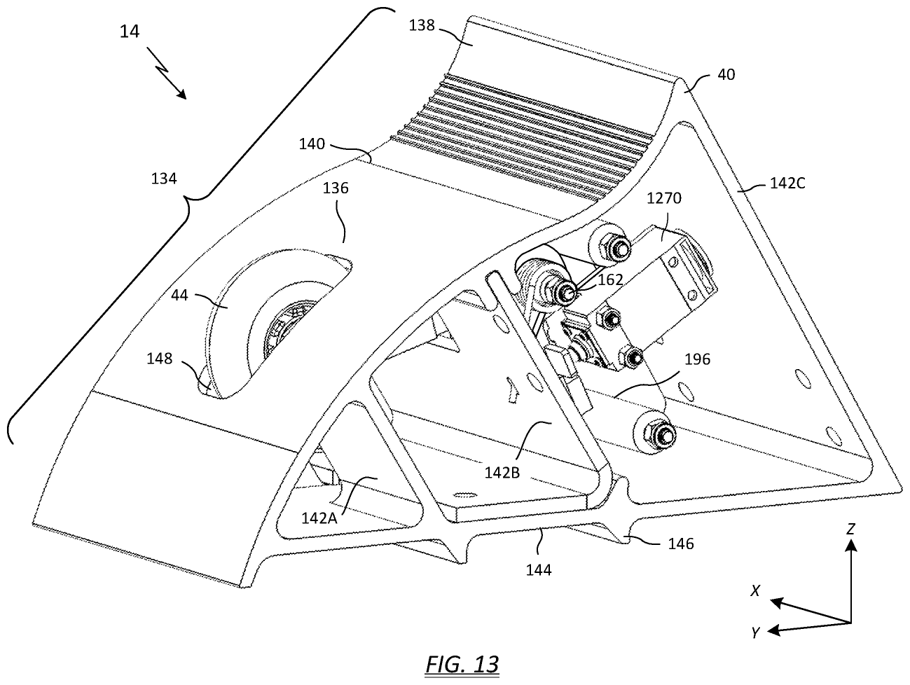

FIG. 9 depicts a simplified overhead view of a properly chocked trailer tire, and one possible location for an outside loading dock camera 68 with a wide enough field of view to view the tire and/or chock. The camera 68 can be mounted in any suitable position to view the truck or trailer wheel 60 and the wheel chock 40. The camera 68 can also be more directly aimed at an angle towards the expected location of the truck or trailer tire to be chocked. It is unimportant whether the camera 68 is mounted below, near, or above the expected tire/chock location as long as it can view the chocked truck or trailer tire. FIGS. 10 and 11 depict a simplified overhead illustration of an incorrectly placed wheel chock 40. All three situations of FIGS. 9-10 can be viewed and interpreted by either by a person viewing the image on a display 72 at the loading dock, persons at one or more remote locations, and/or by an image recognition process adapted to identify wheel chock placement. While ideally the camera is fixed-mounted to avoid the need for operator intervention, the camera can also be mounted on a remote controlled positioning mount. Such a mount can allow a local or remote operator to view other parts of the loading dock. Also, it is contemplated that in some embodiments, an image recognition process as described hereinabove could also move the camera (e.g., fine tune the camera position) to find the wheel and/or the chock if one or both are not already in the image.

A software, firmware, and/or hardware signal and/or contact operation derived from the result of image recognition of safe chock placement can be used to interlock loading dock operations such as opening the loading dock door or operating the loading dock leveler. The result of such image processing of the wheel and chock image can be any suitable wheel chock placement safe/unsafe indication and/or any suitable interlocking functions. For example, there can be an interlock programmed into the controller code (e.g. controller firmware or software) to prevent certain loading dock operations by software control based on the image processing of the image of the wheel and chock. There can also be any suitable digital indication of proper chock placement based on the image processing of the image of the wheel and chock, such as, for example a digital “0” or “1” bit in data which can also be translated to an electrical level and/or a solid state switch status and/or an electrical contact operation (e.g. for hardware interlock purposes, such as, for example, to interlock AC power to a particular device such as a door motor and/or the leveler motor).

In some embodiments, a LCD panel, such as, for example a LCD display on the inside control panel and light box (not shown in the figures) can provide persons near the loading dock within the building truck chocking information from the wheel chock system, such as an image from an outside camera pointed in the vicinity of the rear trailer wheels and chock.

For example, a truck driver deems it unnecessary to properly chock the truck. The driver cheats the chock sensor such as by intentionally placing an item, such as a wallet, over the sensor aperture in the chock. Or, the chock may have been improperly placed under the tire (well enough to trigger the sensor, however unfortunately not well enough to be deemed proper chock placement) by an otherwise well intentioned, but hurried driver. A person at the loading dock viewing the wheel and chock, such as via a LCD display or through the Wi-Fi system on a mobile device can see that the wheel chock has not be properly placed for safe loading dock operation. In the case of a local loading dock operator, the operator refuses to proceed with operation of the loading dock based on the improper or unsafe placement of the wheel chock. In the case of a supervisor viewing the image on a mobile device or on a remote computer, in some embodiments, the supervisor can send a signal to freeze (e.g., by interlocking one or more loading dock electrical components) the operation of the loading dock, such as for example by an application running on the mobile device or remote computer. In other cases, the supervisor can order a halt to loading dock operations by intercom, by walking over to the loading dock, or by calling the operator of the loading dock, or by sending a message which is displayed on the local LCD.

It is contemplated that such supervisory functions can also be accomplished by computer image processing of the image of the wheel and chock. In such an automated supervisory role, the result of the image recognition of an improper chock placement can inhibit or interlock loading dock operations until the image shows a correct chock placement. In such automated image processing installations, there can also be alarms sent by the wireless module, such as by Wi-Fi, from the wheel chock system notifying others by network connection that loading dock operation was attempted with an improper wheel chock placement.

It will be appreciated by those skilled in the art that other notification means can also be used. For example, it is contemplated that a Wi-Fi wheel chock system can also send text messages, send email notifications, and/or make phone calls to announce an alarm condition.

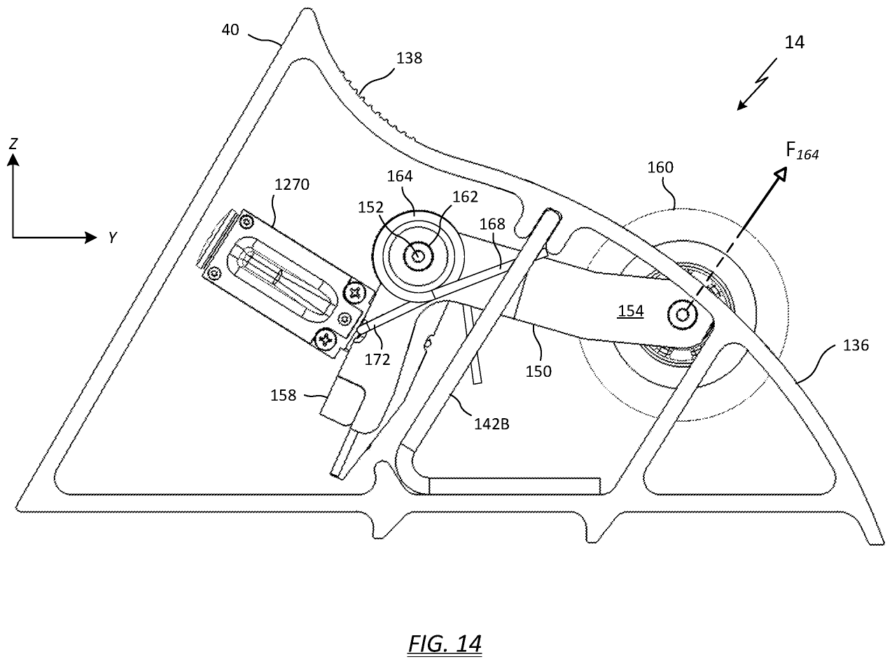

As noted above, the wireless module can be mounted to the wheel chock assembly instead of the inside control panel, and communicate wheel chock system information wirelessly to the controller. Accordingly, one embodiment of the present invention includes wireless transmission of wheel chock sensor data from the chock to the controller at the loading dock. Referring to FIG. 12, wherein like numerals indicate like parts from FIGS. 1-3, depicted is an exemplary wireless wheel chock system 1210 configuration in which the wireless module 1270 is operatively coupled 126 to the wheel chock assembly 14 (also shown in FIG. 1). The wireless module 1270 communicates wheel chock system information via any suitable form of wireless communication 128 such as, for example, any suitable type of radio frequency (RF) wireless communication. The wireless module 1270 can include a transmitter portion 130 located at the wheel chock assembly 14, and a receiver portion 132 operatively coupled to the controller 20. Any suitable computer 12110 connected to network 12108, such as a local area network or the Internet, can receive wheel chock system information 12122 from Wi-Fi module 1270.

FIG. 13 depicts a wheel chock assembly 14 with a wireless module according to one embodiment of the invention. As illustrated, the wheel chock assembly 14 can include a wheel chock 40 having an upward-curving tire contact surface 134 facing the wheel to be chocked. The tire contact surface includes a convex surface 136 having a radius extending generally upwards from the ground surface. The wheel 60 (FIG. 2) engages convex surface 136 rather than a concave surface as found in conventional wheel chocks (see, for example, the chock in FIG. 2). In one example, the radius of curvature of the convex surface 136 may be between 11.0 inches and 14.0 inches, preferably 12.25 inches. In the illustrated embodiment, the tire contact surface further includes a concave extension surface 138 joined to an upper end 140 of the convex surface 136. The concave extension surface 138 acts as a barrier to prevent a vehicle from accidentally driving over the wheel chock 40 without the chock having been removed. In one example, the radius of curvature for the concave extension surface 138 may be between 2.0 inches and 3.0 inches, preferably 2.43 inches. The upper end 140 may be the geometrical inflection point where the tire contact surface transitions from convex to concave. In one example, the upper end 140 of the convex surface 136 may be positioned at an angle in a range between 20 and 30 degrees from horizontal. The tire contact surface may be fabricated from ¼-inch aluminum plate having a width of about 8.0 inches. In other embodiments of the invention, the tire contact surface does not include the concave extension surface 138. In still other embodiments, the tire contact surface may be other geometries besides convex. For example, the tire contact surface may be concave as shown in FIG. 2, or may be flat.

The wheel chock 40 further includes front, middle, and rear support elements 142A, 142B, and 142C, respectively, for transferring tire loading from the contact surface to the ground. In the disclosed embodiment, the support element 142 includes three web support plates welded to the tire contact surface. Each web support plate 142 may be formed from ¼ inch aluminum having a width approximately equal to the tire contact surface.

The wheel chock 40 may further include a ground engaging base portion 144 coupled to the support element 142. The base portion 144 provides structural support to the wheel chock 40 and transfers the loads to the ground. In one embodiment, the base portion 144 may be formed from a single flat plate that contacts the ground. In other embodiments, the base portion 144 may include two or more plate sections welded or otherwise joined to the web support plates. The base plate may be formed from ¼ inch aluminum having a width approximately equal to the tire contact surface (e.g., 8 inches). The front section of the base plate 144 may be welded at one end to the tire contact surface and at the other end to web support plate 142A. The mid-section of the base plate 144 may be welded to the intermediate web support plate 142B. The rear section of the base plate 144 may be welded to the intermediate and aft web support plates 142B, 142C.

In one embodiment of the invention, the base portion 144 can include at least one projection 146 to concentrate the load path to the ground surface. In doing so, the projection(s) 146 push into the ground and greatly increase the horizontal resistance to movement. In the illustrated example, the projections 146 are provided by the edges of the tire contact surface and the web support plates 142. The projections 146 may be disposed at angles relative to horizontal that further increase the horizontal resistance to movement. For example, web support plates 142 may be at an angle between 45 degrees and 60 degrees.

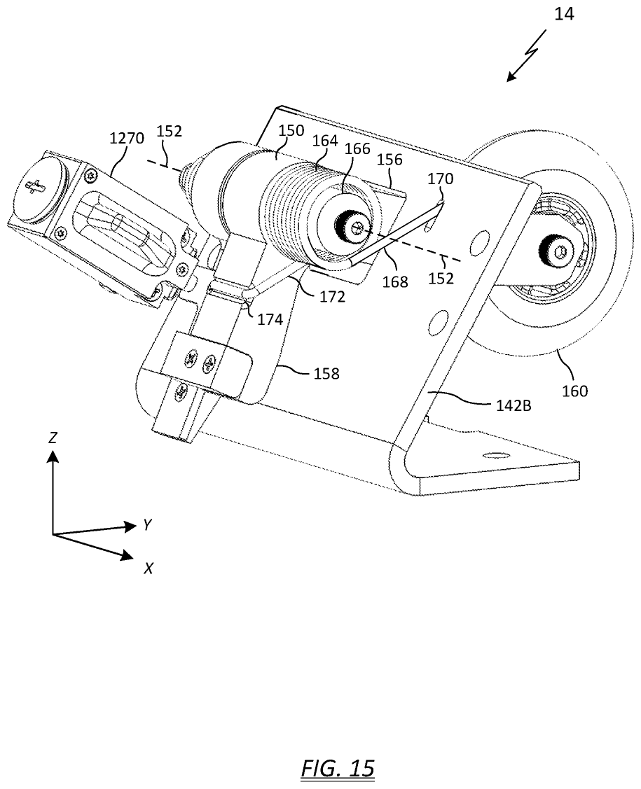

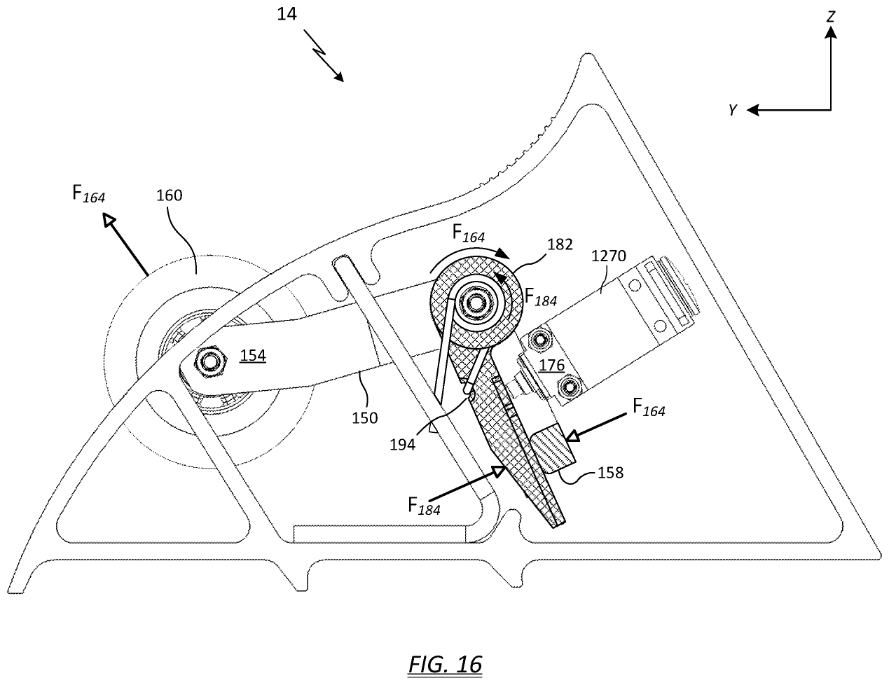

FIG. 14 depicts a left-side view of the wheel chock assembly 14, and FIG. 15 depicts the same left-side view, rotated to a perspective view, with the chock body removed for clarity (e.g., tire contact surface 134, front and rear support elements 142A, 142C, and base portion 144 removed). The wheel chock system 10 may further include a sensor 44 (FIG. 13) for detecting the presence of the wheel 60. The output of sensor 44 may serve as logical input for the dock light warning system 16, 18 (FIG. 1) to assure the presence of the wheel chock 40 against the wheel when a truck is backed into position adjacent a loading dock.

In one possible implementation, the convex surface 136 of the chock defines an aperture 148 (FIG. 13) and the sensor 44 is adapted to measure the presence of the truck tire through the aperture. In the illustrated embodiment, the sensor 44 is a lever arm 150 configured to pivot about an axis 152 that extends transverse relative to the chock 40. The lever arm 150 may be predominantly L-shaped, with a forward leg 154 extending through a cutout 156 in the middle support element 142B, and a rearward leg 158 forming a portion of a trigger mechanism, as will be explained below. The tip of the forward leg 154 may include a contact element 160 to protect the integrity of the lever arm 150. The pivot axis 152 about which the lever arm 150 rotates can be defined by a shoulder bolt 162. Although hidden from view, a rotary thrust bearing may be disposed about the shoulder bolt 162 to permit free rotation of the lever arm 150 and to absorb side loads caused by the tire 60.

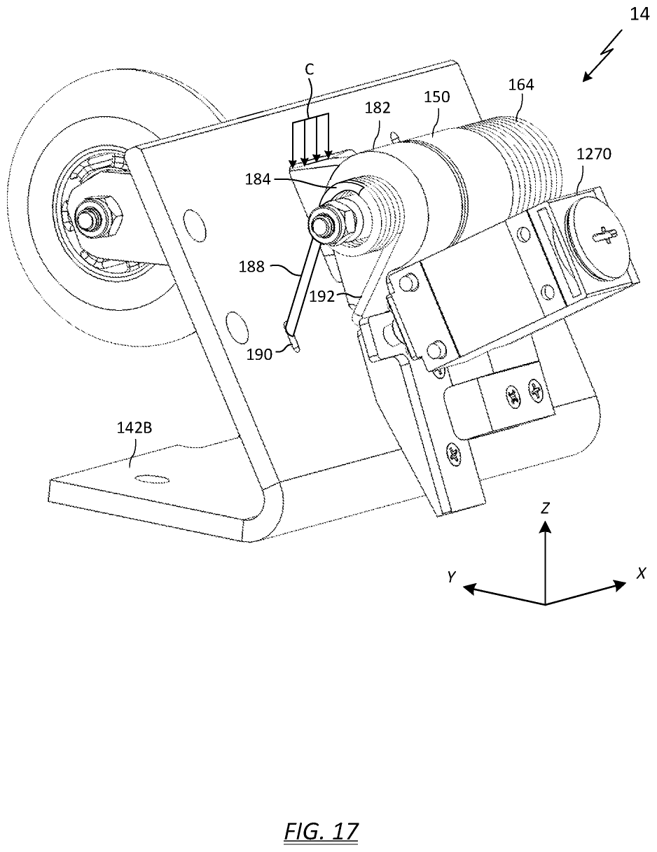

The lever arm 150 may be spring-biased about the axis 152 to ensure the opposing forward leg 154 of the lever arm protrudes through the chock surface aperture 148 and is ‘proud’ relative to the convex surface 136 of the chock. With reference to FIG. 14 and FIG. 15, a lever arm torsion spring 164 can be wound (i.e., pre-loaded) about an arm spring spacer 166 with one leg 168 constrained to a slot 170 in the chock middle support plate 142B, and the opposing leg 172 held into a groove 174 on the upper surface of the lever arm 150. As best seen in FIG. 16, the pre-loaded torsion spring 164 will tend to rotate the lever arm 150 about the axis 152 in a clockwise direction, such that the lever arm rotates up through the aperture 148 in the convex surface 136 of the chock. The lever arm 150 can be configured to butt up against the upper surface of the middle support cutout 156, which effectively stops further upward motion. Contact area “C” in FIG. 17 illustrates an exemplary contact location that prevents the lever arm 150 from further clockwise (i.e., upward) movement. Accordingly, the preload in the lever arm torsion spring 164 results in a preload force F₁₆₄ on the lever arm 150, which must be overcome for the lever arm to move downward.

In one example, the torsion spring 164 can impart a preload force F₁₆₄ of approximately 30 pounds on the lever arm 150. Thus, the lever arm is unlikely to be depressed unless an actual tire is on the chock.

The contact element 160 may be secured to the forward leg 154 of the lever arm 150. The contact element 160 may be the only hardware directly in contact with the truck tire, and therefore may be configured to better withstand the harsh, abrasive conditions likely to be encountered. In one embodiment, the contact element 160 can be a free-spinning wheel assembly having a hardened elastomer tire. In one example, the tire 160 may be formed of urethane having a hardness ranging from 82 A to 101 A.

Turning now to FIGS. 16-18, shown is wireless module 1270 configured to transmit sensor data to the controller 20 at the loading dock 12 (FIG. 1). In one embodiment of the invention, the wireless module 1270 can include a position switch 176. The wheel chock system 10 can be configured such that the rotation of the lever arm 150 (due to the presence of a properly chocked tire) causes the rearward leg 158 to activate the position switch 176, which may then cause the wireless module 1270 to transmit data to a receiver 132 at the loading dock 12 (FIG. 1) indicating the wheel chock 40 is properly positioned against a truck tire. The receiver 132 can relay the chock data to the controller 20, which can command the operation of the loading dock safety interlocks 98, as explained above. The receiver 132 may be a stand-alone unit, or may be integrated with the outside light box 16, the inside control panel 18, or the controller 20. The wheel chock system 10 can further be configured such that, when the wheel chock 40 is removed from the tire 60, the lever arm 150 rotates in the opposite direction (due to the preload in the lever arm torsion spring 164), the rearward leg 158 deactivates the position switch 176, causing the wireless module 1270 to transmit new status data to the receiver 132 at the loading dock 12.

In the illustrated example, the position switch 176 comprises a spring-loaded, depressible plunger 178. The wheel chock system 10 can be configured such that the rotation of the lever arm 150 causes the rearward leg 158 to depress the plunger 178, thereby causing the wireless module to transmit data to the receiver 132. When the wheel chock 40 is removed from the wheel 60, rotation of the lever arm 150 in the opposite direction causes the rearward leg 158 to back off the spring-loaded plunger 178, the plunger snaps back to its original position, and the wireless module 1270 may transmit new status data to the receiver 132 at the loading dock 12.

Wireless module 1270 requires an electrical power source for activation and usage of the circuits to transmit the chock sensor data to the receiver 132. In some embodiments, the power source may be a hard line connection, such as cable 34 shown in FIG. 2. However, the cable 34 requires special additional hardware, such as cable pole 32, to minimize entanglements and interference with loading dock operations. In other embodiments, the power source may comprise a battery, such as a primary cell (i.e., non-rechargeable) or a secondary cell (i.e., rechargeable). However, both battery types have drawbacks. Non-rechargeable batteries frequently need replacement, which requires extra manpower and an exacting maintenance schedule to prevent a discharged battery from interrupting loading dock operations. Rechargeable batteries offer a somewhat better alternative, but still require a charging port in proximity to the chock, which is usually outdoors in the environmental elements. An external charging port therefore requires adequate environmental protection against rain, snow, etc.

In one embodiment of the present invention, these deficiencies are overcome through use of an energy harvesting mechanism to provide an electrical power source for the wireless module 1270. The electrical power required for the transmission can be provided by an electrodynamic energy generator that is activated when the wheel chock properly engages the truck wheel. In one example, the position switch 176 may include an induction generator having an electrically conductive coil core in abutment with a spring-loaded, moveable magnet group. The switch can be configured to form a closed annular magnetic flux through the coil core and magnet group when the magnet group is positioned in a first, at-rest state. Depressing the plunger 178 can release the spring elements in a ‘snap action,’ causing the magnet group to rapidly accelerate to a second, at-rest position. The second position is still in abutment with the coil core, but at a different location. The second position can be configured to reverse the direction of the closed annular magnetic flux. As such, the rapid directional shift in magnetic flux (from the first position to the second position) can induce a voltage in the coil core, which voltage can then be utilized to power the components in the wireless module 1270 and transmit data to the receiver 132 at the loading dock 12. In similar fashion, when the plunger 178 is released, a second spring element can snap the magnet group from the second position back to the first position, once again inducing a voltage in the coil as the magnetic flux changes direction in the coil core.

In one embodiment of the invention, the induced voltage can be used as a supply voltage to power RF electronics in the wireless module 1270. The RF electronics can transmit a radio protocol with message data via an antenna 180 to the receiver 132 at the loading dock. In one example, the transmission is carried out at a frequency of 868.3 MHz or 915 MHz. Exemplary protocols include KNX-RF, ZigBee, Bluetooth Low Energy, or customer-defined proprietary protocols.

The plunger 178 typically travels a short distance, approximately 0.5 inches or less, to release the spring elements in a ‘snap action.’ The short range of travel presents a challenge for the lever arm design, because the movement of the arm follows a one-to-one correspondence with movement of the plunger 178. That is, with nothing more, the lever arm 150 must be designed to travel no more than the plunger travel. Otherwise, one concern with this configuration is that the lever arm 150 could over-travel and crush the position switch 176 and plunger 178. A design that allowed the contact element 160 to protrude only 0.5 inches proved difficult.

One solution to this problem was to alter the 1:1 ratio in favor of the lever arm, such that larger ranges of motion at the forward leg 154 of the lever arm 150 translated to smaller ranges of motion at the plunger 178. Such configurations could involve gears, cams, or springs and the like.

Another solution, which is illustrated and described herein, adds a safeguard mechanism to prevent over-travel against the plunger 178 and body of the position switch 176. Embodiments of the present invention include a trigger arm 182 operating in concert with the lever arm 150. The motion of the trigger arm 182 contacts and depresses the plunger 178, but its range of motion is impeded thereafter. Meanwhile, the motion of the lever arm 150 may continue unimpeded.

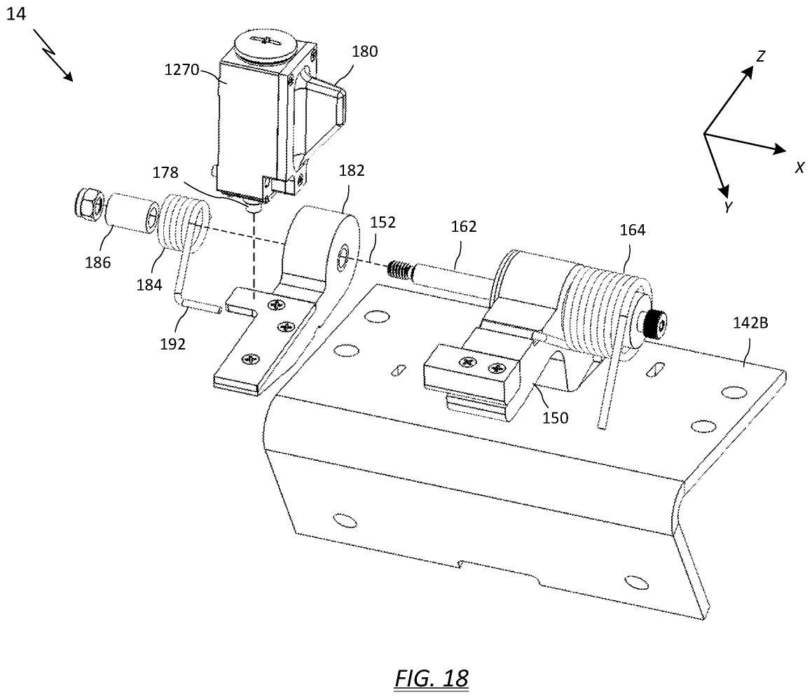

Referring generally to FIGS. 16-18, and in particular to FIG. 18, the trigger arm 182 can be configured to pivot about the same axis 152 as the lever arm 150. In the illustrated example, the trigger arm 182 mounts to the shoulder bolt 162. The trigger arm 182 can be spring-biased towards the plunger 178 to ensure positive contact when the plunger is depressed. In one embodiment, a trigger torsion spring 184 can be wound (i.e., pre-loaded) about a trigger spacer 186. A first leg 188 of the trigger torsion spring 184 can be constrained to a slot 190 in the middle support plate 142B, and the opposing leg 192 of the torsion spring can be retained in a groove 194 on the upper surface of the trigger arm 182.

As best seen in FIG. 16, wherein the end face 158 of the lever arm 150 is shaded and the trigger arm 182 is cross-hatched, the pre-loaded trigger torsion spring 184 will tend to rotate the trigger arm 182 about the axis 152 in a counter-clockwise direction, towards the plunger 178. As illustrated in FIG. 16, the trigger torsion spring 184, when pre-loaded, causes the trigger arm 182 to rotate in a counter-clockwise direction until it makes contact with and is stopped by the underside surface of the lever arm end 158. Accordingly, the preload in the trigger torsion spring 184 results in a preload force F₁₈₄ on the trigger arm 182 (see arrows), which force is in opposing relation to spring force F₁₆₄. In one embodiment, the spring force F₁₆₄ is greater than spring force F₁₈₄, so the lever arm 150 effectively impedes further motion of the lesser-force trigger arm 182. In one example, the lever torsion spring 164 can impart a preload force F₁₆₄ of approximately 30 pounds on the lever arm 150, and the trigger torsion spring 184 can impart a preload force F₁₈₄ of approximately 15 pounds on the trigger arm 182. Although there appears to exist a net positive force against the trigger arm, such that the lever arm would push the trigger arm backwards (i.e., clockwise in FIG. 16) the lever arm pre-load force is actually counteracted at contact surface C (FIG. 17), and the lever arm is constrained from rotating any further in the clockwise direction.

In the above example embodiment, the pre-load values of the torsion springs establish a first position for the wheel chock assembly 14, in which the lever arm 150 and/or contact element 160 can be retained in a position raised above the tire contact surface 134, and the trigger arm 182 can be retained in a position away from the plunger 178 on the position switch 176. No elements of the chock assembly 14 are capable of movement until a vehicle tire bears against the lever arm. As will be explained below, a second, intermediate position can be established when the lever arm 150 moves enough to permit the trigger arm 182 to depress the position switch 176, at which point the trigger arm can be restrained from further movement. The lever arm 150 and/or contact element 160 can still be protrude above the chock tire contact surface at the intermediate position. Finally, a third, max-travel position can be established wherein the lever arm 150 and/or contact element 160 can be fully pushed down into the chock body, flush or below the tire contact surface 134.

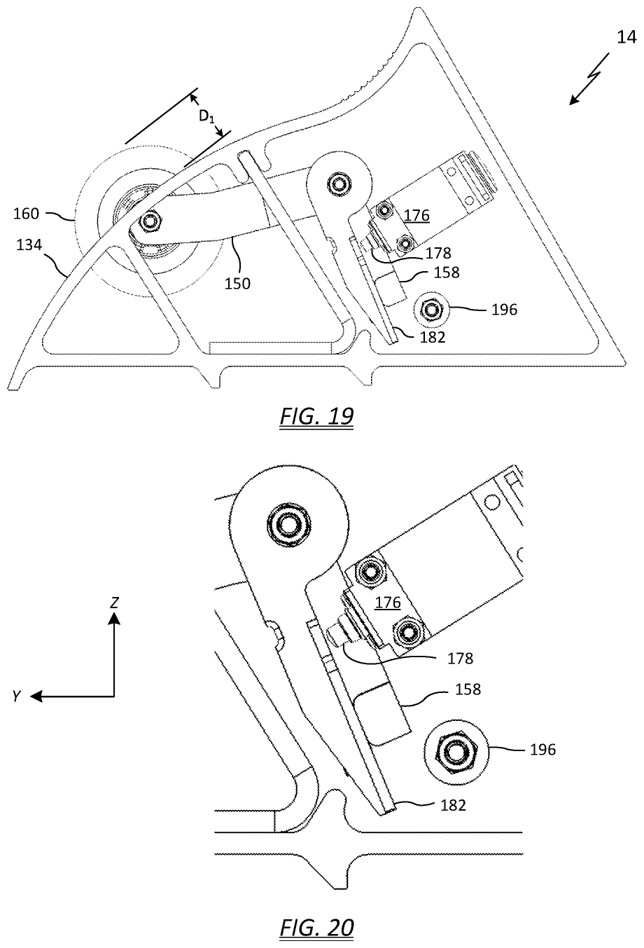

FIGS. 19 and 20 illustrate the wheel chock assembly 14 in the first position, which is essentially the same view as FIG. 16, except the torsions springs have been removed for clarity. The contact element portion 160 of the lever arm 150 is retained in a position protruding above the tire contact surface 134 a distance D₁. The safeguard trigger arm 182 is biased against the rearward leg 158 of the lever arm 150, and is spaced away slightly from the plunger 178 of the position switch 176. Also illustrated is an end view of stiffener bolt 196, which can be used to strengthen the frame of the wheel chock 40. A perspective view of the stiffener bolt 196 is illustrated in FIG. 13.

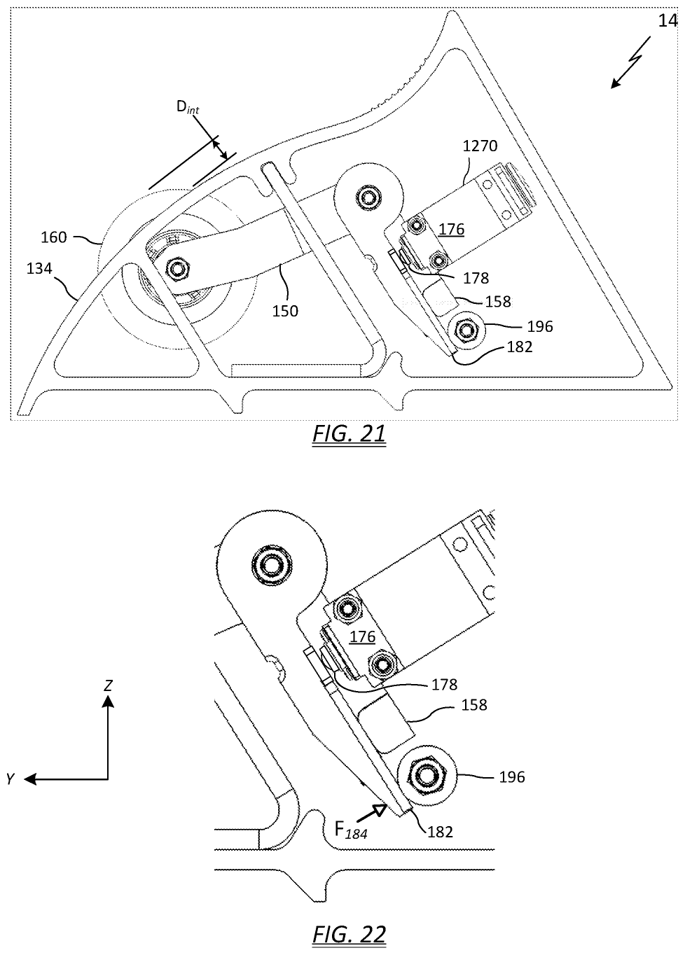

FIGS. 21 and 22 illustrate the wheel chock assembly 14 in the intermediate position. The contact element portion 160 of the lever arm 150 has been pushed down by the vehicle tire such that it is raised above the tire contact surface 134 a distance Dᵢₙₜ, so the lever arm 150 has not yet achieved full travel. The safeguard trigger arm 182, being biased towards a counter-clockwise rotation, remains abutted against and therefore follows the underside surface of the lever arm end 158 as the lever arm rotates counter-clockwise due to the action of the vehicle wheel. At the illustrated intermediate position, the trigger arm 182 has depressed the position switch plunger 178, which causes the wireless module 1270 to send a message to the controller 20 at the loading dock. At the same time, the tip of the trigger arm 182 encounters the stiffener bolt 196, which is rigidly fixed to the wheel chock housing. Therefore, once the trigger arm 182 depresses the plunger 178, it is constrained by the stiffener bolt 196 from rotating any further in the counterclockwise direction. The constraint prevents the plunger 178 and position switch 176 from being crushed by the trigger arm. Note that the trigger torsion spring 184 preload force F₁₈₄ biases the trigger arm against the stiffener bolt 196 to hold it in place.

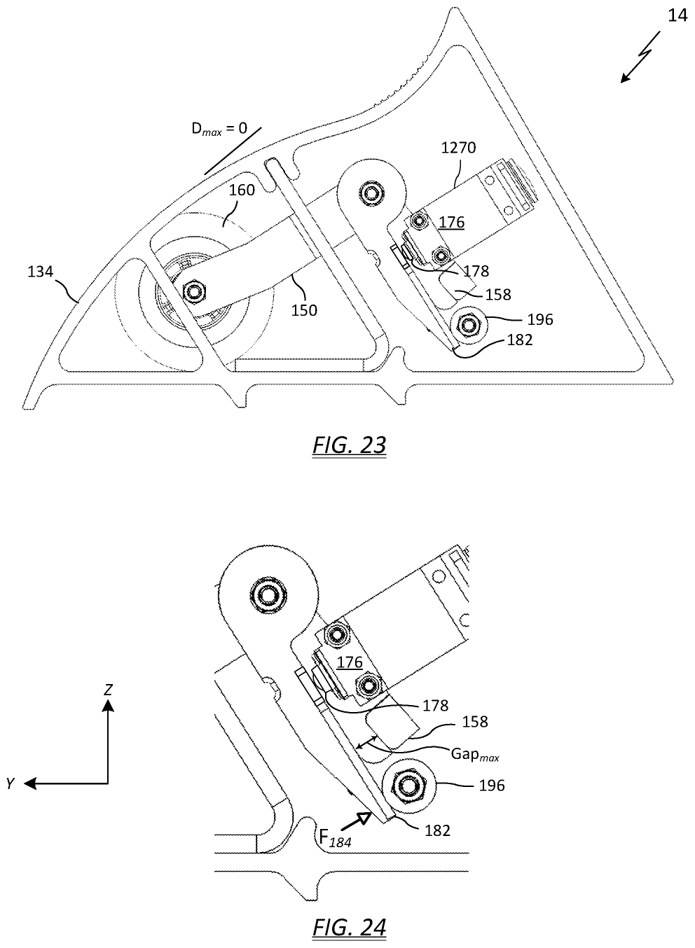

Even though the motion of the safeguard trigger arm 182 is impeded at the intermediate position, the lever arm 150 may continue its movement as the vehicle wheel pushes the contact element 160 into the chock housing. FIGS. 23 and 24 illustrate the wheel chock assembly 14 in the maximum travel position. The contact element portion 160 of the lever arm 150 has been pushed down flush or below the tire contact surface 134, such that Dₘₐₓ is equal to zero. Referring to FIG. 24, note how the full travel of the contact element 160 caused the rearward leg 158 of the lever arm to move a distance Gapₘₐₓ away from the trigger arm 182, because the trigger arm is constrained from further rotation by the stiffener bolt 196.

As discussed above, when the wheel 60 pushes down on the contact element 160 to a height of Dᵢₙₜ, the trigger arm 182 depresses the position switch plunger 178 and the wireless module 1270 sends a message to the controller 20 at the loading dock that the wheel is chocked. Conversely, when the chock 14 is removed from the wheel, the contact element 160 raises up above the tire contact surface 134 and, and upon reaching height Dᵢₙₜ, the position switch plunger 178 is released, returning to the position shown in FIGS. 19-20, which causes the wireless module 1270 to send a message to the controller 20 at the loading dock that the chock is removed.

One problem unique to the loading dock industry are the dynamic forces on the chock during trailer loading and unloading operations. Very often the trailer jumps up and down as fork lifts and pallets are loaded or unloaded from the trailer. As a result, the tire on the chock may also bounce up and down or otherwise move about. This dynamic movement may be on the order of an inch or two, but the movement can be enough to exceed height Dᵢₙₜ, which would also pivot the lever arm 150 and back off the plunger 178 enough to snap it back to the uncompressed position. Such action would cause a false signal to be transmitted to the loading dock that the trailer was no longer chocked.

In one embodiment of the invention, this ‘false signal’ problem can be solved by applying a biased dead band to the intermediate height Dᵢₙₜ, such that the point of engagement of the switch is not the same as the point of disengagement. In other words, the ‘throw’ of the position switch plunger 178 may be different for signaling chocking versus unchocking.

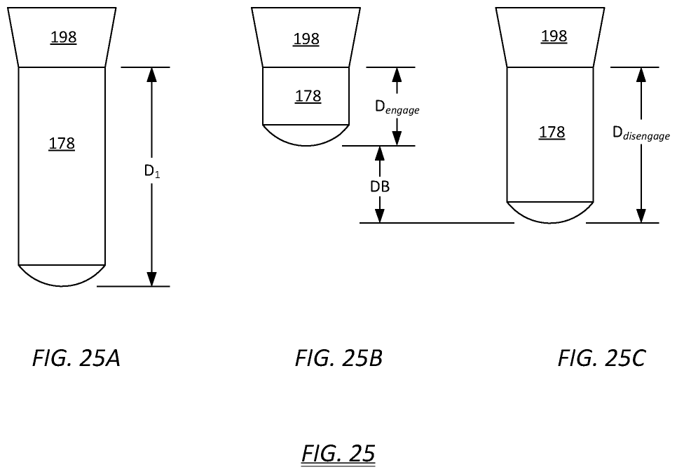

Referring now to FIG. 25, shown are various positions for a plunger 178 on a position switch according to one embodiment of the present invention. FIG. 25A depicts the plunger 178 in the first position, fully extended a distance D₁ from its housing 198, prior to a wheel engaging the chock. FIG. 25B depicts the plunger 178 in the intermediate position, at the moment the plunger is compressed far enough into the housing 198 to engage the switch. The difference between the fully extended length D₁ and the intermediate extended length D_{engage} when the switch is activated is the ‘throw distance,’ or (D₁−D_{engage}). FIG.25C illustrates the plunger 178 in the intermediate position, at the moment the plunger is extended far enough from the housing 198 to disengage the switch. The difference (D_{disengage}−D_{engage}) between the intermediate point of engagement and the intermediate point of disengagement is the dead band DB. The extra travel distance before disengaging compensates for the dynamic motion of the trailer.

In the illustrated embodiment, the dead band is provided by a mechanical means. However, it is contemplated the dead band could also be provided electronically.

While the network of loading dock controllers has been described hereinabove with respect to embodiments of wheel chock systems, there can also be loading dock safety systems which similarly incorporate an outside light box, and inside light box, and a controller which can be used independently of a wheel chock or wheel chock assembly (e.g., without a wheel chock by design, or where there is a broken or severed wheel chock assembly). Such loading dock safety systems can provides safety signaling of all of the signaling types described hereinabove (e.g., lights, audio alarms, and network based messaging and alarms) based on other loading dock parameters. For example, such a safety system might use a subset of the safety related parameters used by a wheel chock system, including loading dock door position and/or movement, safety chain across the loading dock opening in place or open, etc. There can also be additional sensors of any suitable type. For example, even in the absence of a smart chock assembly, there can still be a camera with a view of a truck or trailer wheel that can manually (e.g., by operator observation) or automatically (e.g., by controller or any other suitable computer) image recognition identify the presence of a truck or trailer wheel or tire at the loading dock. Or, where a conventional (not smart) wheel chock is present for use by a truck driver arriving at the loading dock, any of the imaging methods described hereinabove can be used. Any such safety systems can be networked using any of the techniques described hereinabove with respect to wheel chock embodiments.

A microcomputer is understood to include a microcontroller, a microprocessor, or any suitable device configured to perform the functions of a microcomputer, such as, for example, an application specific IC (ASIC) or field programmable gate array (FPGA). The controller functions can also be performed by any suitable computer, such as, for example by a notebook, desktop, or netbook computer.

Any suitable computer device can interact with a wireless wheel chock system. For example, a Wi-Fi wireless wheel chock system can interact with any suitable network connected computer or mobile device, such as, for example, a desktop computer, notebook computer, a netbook computer, a laptop computer, a tablet computer, or a smart phone. A standard telephone or cell phone can suffice the case of automated calls alarms from a wheel chock system.

Firmware or software running on the microcomputer of the controller or on another computer (e.g. image processing or alarm indications) is typically supplied on a computer readable non-transitory storage medium. A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, etc.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment. For example, many illustrated embodiments herein disclosed a convex wheel chock. However, the embodiments could also be used with a conventional concave wheel chock.

The following is claimed:

1. A wheel chock system for a vehicle tire, comprising:
a wheel chock assembly, comprising:
a wheel chock comprising a tire contact surface, one or more support elements, and a base portion;
a sensor for use in detecting a chocked vehicle tire, the sensor being located proximate the wheel chock; and
a wireless module operatively coupled to the sensor, the wireless module comprising a wireless transmitter and a receiver;
and
a controller operatively coupled to the receiver, the controller comprising one or more computer-readable storage devices, and program instructions stored on at least one of the storage devices, the stored program instructions comprising program instructions to change the status of a safety parameter in response to the sensor detecting a chocked vehicle tire.

2. The wheel chock system of claim 1, wherein the tire contact surface of the wheel chock comprises a convex surface.

3. The wheel chock system of claim 2, wherein the tire contact surface further comprises a concave extension surface joined to an upper end of the convex surface.

4. The wheel chock system of claim 1, wherein the safety parameter is a visual indication on a light box.

5. The wheel chock system of claim 1, wherein the safety parameter is a loading dock interlock.

6. The wheel chock system of claim 1, wherein the sensor comprises a lever arm having a forward leg and a rearward leg, the forward leg protruding through an aperture in the tire contact surface of the chock, and the rearward leg forming a portion of a trigger mechanism.

7. The wheel chock system of claim 6, wherein the sensor further comprises a contact element at the tip of the forward leg, the contact element comprising a free-spinning wheel assembly.

8. The wheel chock system of claim 6, further comprising a lever arm spring to bias the forward leg through the aperture in the tire contact surface.

9. The wheel chock system of claim 8, wherein the lever arm spring is a torsion spring.

10. The wheel chock system of claim 6, wherein at least a portion of the trigger mechanism comprises a position switch activated by the rearward leg of the lever arm.

11. The wheel chock system of claim 10, wherein the position switch comprises an electrodynamic energy generator for inducing a voltage to power the transmitter of the wireless module.

12. The wheel chock system of claim 11, wherein the transmitter transmits an RF radio protocol with message data to the receiver, the message data comprising wheel chock system information.

13. In a wheel chock comprising a tire contact surface, one or more support elements, and a base portion, a sensor located proximate the wheel chock for use in detecting a chocked vehicle tire, the sensor comprising:
an axis;
a lever arm pivoting about the axis, the lever arm comprising a forward portion and a rearward portion, the forward leg portion protruding through an aperture in the tire contact surface of the chock, the lever arm having a range of motion defined by a first position wherein the forward leg protrudes through the aperture a first distance, an intermediate position wherein the forward leg protrudes through the aperture a second distance greater than zero and less than the first distance, and a third position wherein the forward leg is flush with or below the tire contact surface;
a trigger arm coupled to the lever arm range of motion pivoting about the axis; and
a wireless module coupled to the trigger arm, the wireless module comprising a transmitter and an electrodynamic energy generator for inducing a voltage to power the transmitter;
wherein, when the motion of the lever arm reaches the intermediate position, the trigger arm activates the wireless module to wirelessly transmit message data comprising wheel chock system information.

14. The wheel chock sensor of claim 13, further comprising a lever arm spring to bias the forward leg through the aperture in the tire contact surface.

15. The wheel chock sensor of claim 13, wherein, when the motion of the lever arm reaches the intermediate position, the trigger arm decouples from the lever arm to stop its motion.

16. The wheel chock sensor of claim 15, further comprising a trigger arm spring to bias the trigger arm towards the wireless module.

17. The wheel chock sensor of claim 13, wherein the wireless module further comprises a position switch coupled to the trigger arm.

18. The wheel chock sensor of claim 17, wherein the position switch comprises a plunger coupled to the trigger arm.

19. The wheel chock system of claim 13, further comprising a lever arm torsion spring disposed about the axis rod to bias the forward leg through the aperture in the tire contact surface, and a trigger arm torsion spring disposed about the axis rod to bias the trigger arm towards the wireless module.

20. The wheel chock system of claim 19, wherein the trigger arm torsion spring bias opposes the lever arm torsion spring bias, and the lever arm torsion spring bias is a greater magnitude than the trigger arm torsion spring bias.
